(19) United States
(12) Patent Application Publication
(10) Pub. No.: US 2024/0157593 A1
(43) Pub. Date: May 16, 2024

(54) DEEP-THROAT SAWHEAD ASSEMBLY AND KIT THEREOF

(71) Applicant: Norwood Industries Inc., Oro-Medonte (CA)

(72) Inventors: Ashlynne DALE, Oro-Medonte (CA); Sebastien CABRIT, Oro-Medonte (CA)

(73) Assignee: Norwood Industries Inc., Oro-Medonte (CA)

(21) Appl. No.: 18/418,540

(22) Filed: Jan. 22, 2024

Related U.S. Application Data
(63) Continuation of application No. 17/471,451, filed on Sep. 10, 2021.

(30) Foreign Application Priority Data
Sep. 11, 2020 (CA) 3092814

(51) Int. Cl. B27B 13/02; B27B 13/10; B27B 15/02

(52) U.S. Cl. CPC B27B 13/02; B27B 13/10; B27B 15/02

(57) ABSTRACT

A sawmill and a kit for forming the sawmill has a support assembly, a sawhead, a log bed and a carriage. The support assembly retains a motor relative to a drive bandwheel and a free bandwheel in a sawmill. The support assembly has a first platform orientated on a first plane, where the first platform securable to an axle of the drive bandwheel. The support assembly has a second platform orientated on a second plane, where the second platform securable to an axle of the free bandwheel. The support assembly also has a centre platform coupled to, and between, the first and second platforms, where the centre platform is orientated on a third plane that is vertically spaced apart from the first and second planes. The centre platform is configured to support the motor above the axles of the drive bandwheel and the free bandwheel.

### RELATED APPLICATION

This application claims priority to U.S. application Ser. No. 17/471,451 filed Sep. 10, 2021, and Canadian Patent Application No. 3,092,814 filed Sep. 11, 2020, both of which are hereby incorporated herein by reference.

### FIELD OF THE INVENTION

The present invention relates generally to a sawhead for a band saw for sawing lumber. In particular, the present invention relates to a support assembly for supporting a drive bandwheel, a free bandwheel, and a motor in a sawmill.

### BACKGROUND OF THE INVENTION

A conventional band saw typically has a relatively large band saw blade, mounted in a sawhead along the path of travel of a log placed on a suitable moving bed with a drive mechanism for advancing the log against the blade. Alternatively, the log remains stationary and the sawhead is mounted on a carriage which is capable of transverse displacement along the log.

Typically, the band saw blade is entrained between two bandwheels which are driven by a motor. The motor is usually situated on the sawhead between the two bandwheels and may be protected by a cover. The maximum vertical distance between the motor, the sawhead, and the cover to the band saw blade is often called the “throat clearance” or “throat capacity”. The throat clearance dictates the maximum depth of cut that can be accommodated by the blade relative to the top surface of the log, i.e. it limits the maximum thickness of lumber that can be cut.

In order to increase the throat clearance, existing sawheads have been modified by using a combination of welded and machined metal parts in order to lower the bandwheels below the sawhead. Lowering the bandwheels results in a lower band saw blade relative to the sawhead and increases the distance between the band saw blade to the motor, the sawhead and the cover, thereby increasing the throat clearance.

Lowering the bandwheels requires complex and costly fixturing, welding, and gusseting of sawhead structures. Such fixturing results in a decrease in rigidity. There is thus a need for an improved portable sawmill having a greater throat clearance while maintaining rigidity.

### SUMMARY OF THE INVENTION

During milling, the band blade spins around the bandwheels at very high velocity and under high tension. Obviously the blade has to be under high tension or it would not cut. Remaining on track is difficult. Even a small misalignment in the bandwheels will cause the blade to crawl or fly off the bandwheels.

However, when tension is applied to the saw blade, the structure wants to flex—flex can happen in the bandwheel axles, in the interface between the axles and the sawhead, or in the sawhead itself. So the structure in aggregate must resist deformation/torsion otherwise the alignment of the bandwheels will be compromised and the blade will not run true anymore.

There are sawmills that offer a deep throat, but to do that, they need to “drop” the bandwheels relative to the engine/clutch and, to do that, they need elaborate weldments with multiple sub-assemblies, much gusseting, heavy plate metal and complex welds that must be very precisely fixtured to allow the distance but also deny torsion and so preserve perfect alignment. That type of sawhead is expensive and time-consuming not only to make but to quality check. To ensure proper bandsaw tracking on bandwheels, the distance from each bandwheel, and the alignment of each bandwheel and the saw blade, the bandwheels must remain absolutely fixed in their predetermined locations. In addition, the bandsaw blade is under high pressure during operation, thereby requiring that the sawhead structure must be highly rigid to resist deflection and torsion.

The present invention provides a support assembly for retaining a motor relative to a drive bandwheel and a free bandwheel in a sawmill, the support assembly comprising: a first platform orientated on a first plane, the first platform securable to an axle of the drive bandwheel; a second platform orientated on a second plane, the second platform securable to an axle of the free bandwheel; and a centre platform coupled to, and between, the first and second platforms, the centre platform orientated on a third plane vertically spaced apart from the first and second planes, the centre platform configured to support the motor above the axles of the drive bandwheel and the free bandwheel.

The invention also teaches a sawhead for use in a sawmill, the sawhead comprising: the support assembly described above; a motor supported by the centre platform of the support assembly; a drive bandwheel with a drive axle secured to the first platform of the support assembly, the drive bandwheel operatively coupled to the motor; a free bandwheel with a free axle secured to the second platform of the support assembly, the free bandwheel operatively coupled to the drive bandwheel via a blade; wherein the position of the centre platform above the axles enlarges a throat clearance between the blade and the centre platform.

There is also provided a kit for assembling a support assembly for use in a sawmill, the kit comprising: a first structural member and a second structural member, each structural member comprising: a first segment orientated on a first plane, a second segment orientated on a second plane, a centre segment orientated on a third plane that is vertically spaced apart from the first and second planes, and a joint segment connecting the first segment with one end of the centre segment, and another joint segment connecting the second segment with another end of the centre segment; and spacer components for securing the first and second structural members together, spaced apart from one another.

### BRIEF DESCRIPTION OF THE DRAWINGS

FIG. 1 is an upper, front perspective view of a support assembly according to an embodiment of the present invention.

FIG. 2 is an upper, rear perspective view of the support assembly of FIG. 1.

FIG. 3 is a rear elevational view of the support assembly of FIG. 1.

FIG. 4 is front elevational view of the support assembly of FIG. 1.

FIG. 5 is a right side view of the support assembly of FIG. 1.

FIG. 6 is a left side view of the support assembly of FIG. 1.

FIG. 7 is a plan view of the support assembly of FIG. 1.

FIG. 8 is an exploded rear perspective view of the support assembly of FIG. 1.

FIG. 9 is a rear perspective view of structural members of FIG. 8 in isolation.

FIG. 10 is a rear perspective view of a sawhead with the support assembly of FIG. 1 incorporated therein.

FIG. 11 is a rear elevational view of the sawhead of FIG. 10.

FIG. 12 is a front perspective view of the sawhead of FIG. 10.

FIG. 13 is a front elevational view of the sawhead of FIG. 10.

FIG. 14 is a right side view of the sawhead of FIG. 10.

FIG. 15 is a left side view of the sawhead of FIG. 10.

FIG. 16 is a plan view of the sawhead of FIG. 10.

FIG. 17 is a bottom elevational view of the sawhead of FIG. 10.

FIG. 18 is a partially exploded rear perspective view of the sawhead of FIG. 10.

FIG. 19 is a rear perspective view of the sawhead of FIG. 10 mounted on a carriage.

FIG. 20 is a front, left perspective view of the sawhead and the carriage of FIG. 19.

FIG. 21 is a rear perspective view of the sawhead and carriage of FIG. 19 incorporated in a sawmill.

FIG. 22 is a rear elevational view of the sawmill of FIG. 21.

FIG. 23 is a front, left perspective view of the sawmill of FIG. 21.

FIG. 24 is a front elevational view of the sawmill of FIG. 21.

### DETAILED DESCRIPTION OF THE PREFERRED EMBODIMENTS

As illustrated in the Figures, the present invention provides a support assembly 10 for retaining a motor 72 relative to a drive bandwheel 74 and a free bandwheel 76 in a sawmill 100.

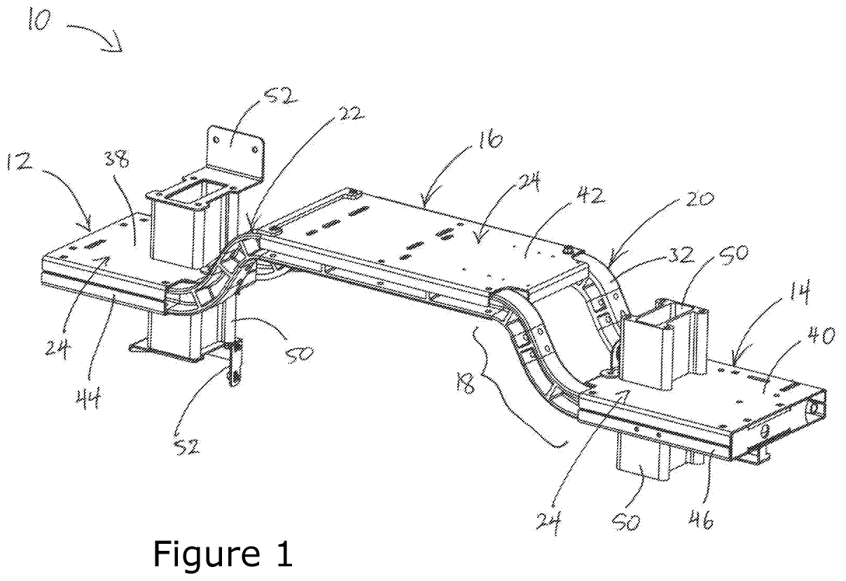

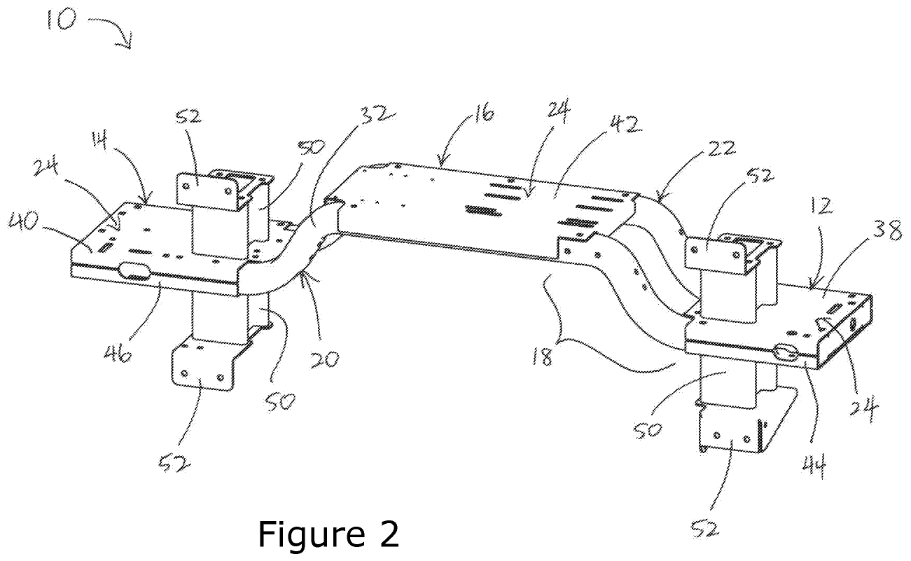

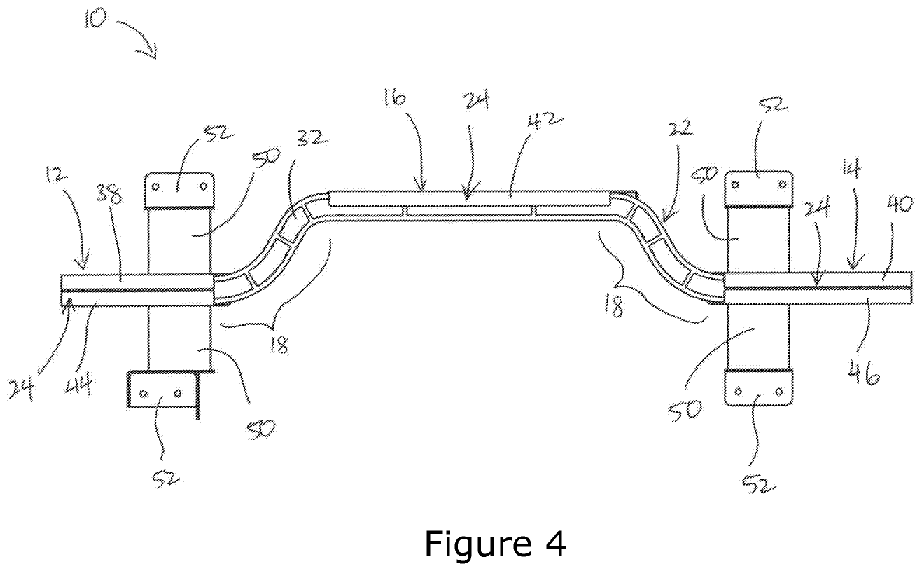

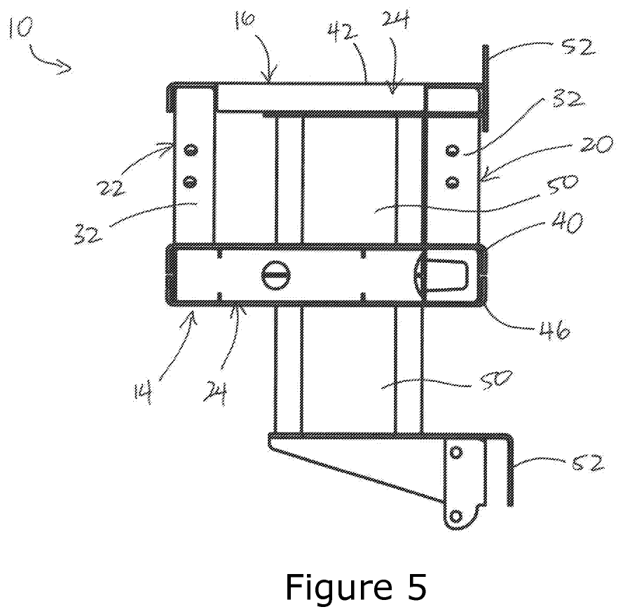

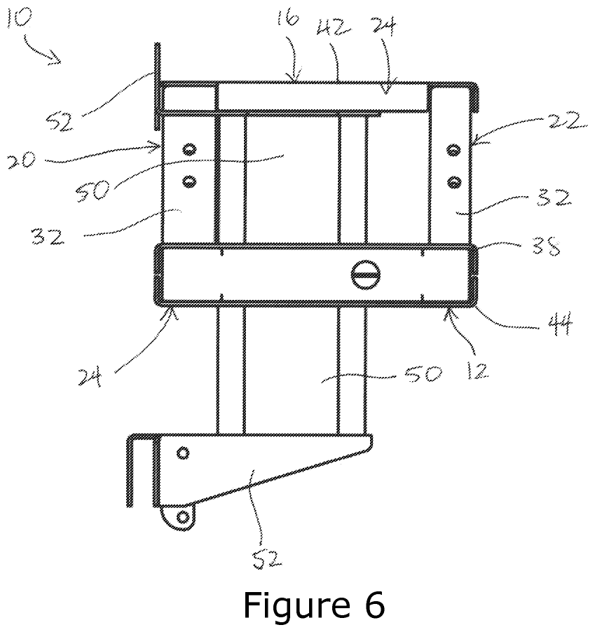

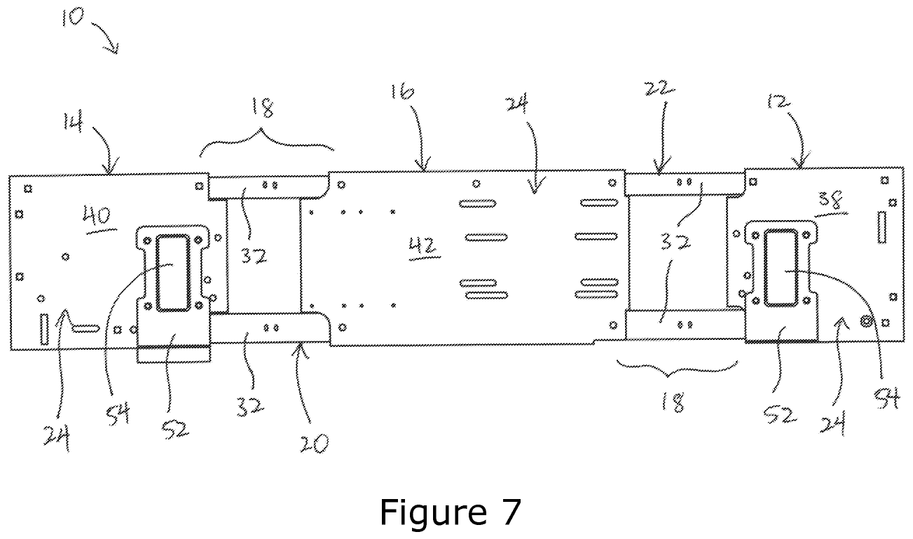

FIGS. 1-9 illustrate an embodiment of support assembly 10. In that regard, support assembly 10 generally includes a first platform 12, a second platform 14, and a centre platform 16 coupled to, and between, first and second platforms 12, 14.

First platform 12 is orientated on a first plane and is securable to an axle of the drive bandwheel. Second platform 14 is orientated on a second plane, which can be the same as the first plane, and is securable to an axle of the free bandwheel. Centre platform 16 is orientated on a third plane that is spaced apart from the first and second planes.

Centre platform 16 is configured to elevate and support the motor. Thus, the third plane on which the motor is supported is offset, or vertically spaced apart, from the first and second planes in which the axles of the drive bandwheel and the free bandwheel are situated. In this manner, in use, centre platform 16 retains the motor above the axles of the drive bandwheel and the free bandwheel, as will be discussed in further detail below.

Returning to the present embodiment, the first plane is aligned, or coplanar, with the second plane, and the third plane is orientated parallel with the first and second planes. In alternate applications, first platform 12 may be offset from second platform 14. In yet other applications, first, second, and third platforms 12, 14, 16 may be orientated at an angle relative to one another, i.e. non-parallel.

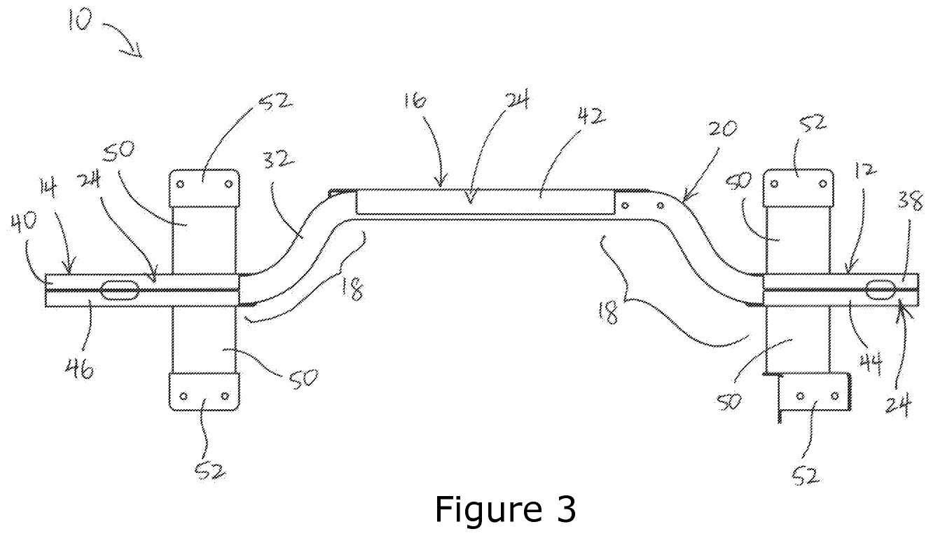

As seen in FIG. 3, support assembly 10 further includes a pair of joints 18, with one joint 18 connecting first platform 12 with one end of centre platform 16, and the other joint 18 connecting second platform 14 with an opposed end of centre platform 18. While the depicted joints 18 are shown to be smooth, curved portions of support assembly 10, in other cases, joints 18 may be angular and/or have a linear configuration.

First, second, and third platforms 12, 14, 16 and joints 18 may collectively be a single, formed unit, or may comprise modular units that are securable together to form support assembly 10.

Alternately, the depicted embodiment illustrates first, second, and centre platforms 12, 14, 16, and joints 18 collectively comprising a first structural member 20, a second structural member 22, and spacer components 24. Spacer components 24 secure first and second structural members 20, 22 together, but spaced apart from one another. As shown, first and second structural members 20, 22 are secured parallel to one another. In some applications, first and second structural members 20, 22 may be tubular or have an I-beam or U-beam cross-section.

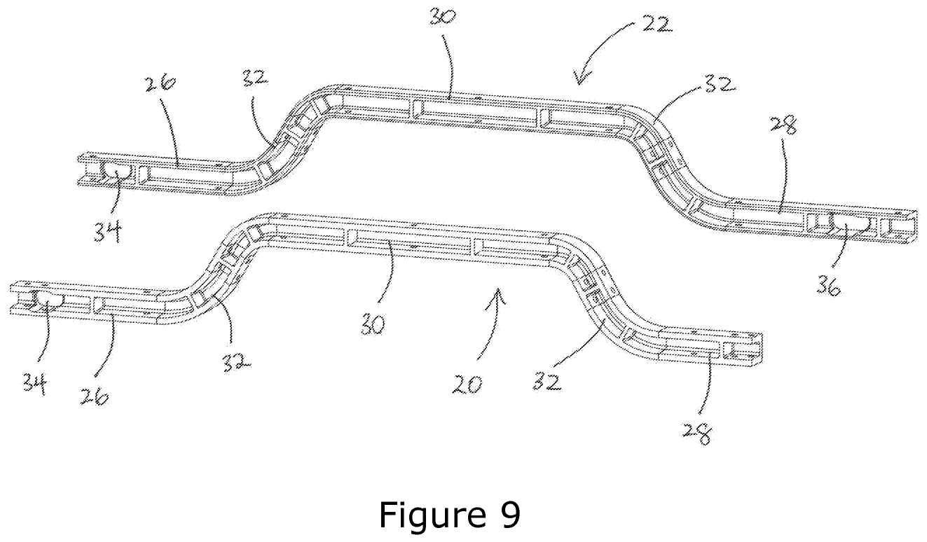

As best seen in FIG. 9, first and second structural members 20, 22 each have a first segment 26, a second segment 28, a centre segment 30, and a pair of joint segments 32. One joint segment 32 connects first segment 26 with one end of centre segment 30, and the other joint segment 32 connects second segment 28 with another end of centre segment 30. First segment 26, second segment 28, and centre segment 30 are shown to be linear, while joint segments 32 are shown to be curved. While the depicted joint segments 32 are shown to be smooth and curved, in other cases, joint segments 32 may be angular and/or have a linear configuration.

In use, joint segments 32 connecting first segments 26 with centre segments 30 of both first and second structural members 20, 22 collectively form one joint 18, while joint segments 32 connecting second segments 28 with centre segments 30 of both first and second structural members 20, 22 collectively form another joint 18.

The segments may be separate components that are secured or welded together. However, in the present preferred embodiment, first, second, centre, and joint segments of each structural member 20, 22 are formed and created as a single unit. This is preferred as it requires no welding or other fastening. In that manner, for example, each structural member 20, 22 may be cast in iron or aluminum. In other applications, structural members 20, 22 may be cast or molded in different metals, alloys, or materials. Structural member 20, 22, each cast as a single unit, helps to provide rigidity to support assembly 10. As cast parts, multiple structural member may also be created consistently and accurately.

As also shown in FIG. 9, first structural member 20 further includes a drive axle aperture 34 positioned in first segment 26 for receiving the axle of the drive bandwheel therethrough. Drive axle aperture 34 is shown located proximate the distal end of first segment 26 of first structural member 20. Alternately, drive axle aperture 34 may instead be located at a different position along first segment 26.

Second structural member 22 also includes a drive axle aperture 34 positioned in first segment 26 for receiving the axle of the drive bandwheel therethrough. Unlike first structural member 20, however, second structural member 22 also includes a free axle aperture 36 positioned in its second segment 28 for receiving the axle of the free bandwheel therethrough. Drive axle aperture 34 and free axle aperture 36 are shown located proximate the respective distal ends of first and second segments 26, 28 of second structural member 22. Alternately, drive axle aperture 34 and free axle aperture 36 may instead be located at different positions along first and second segments 26, 28 respectively, so long as drive axle apertures 34 in first and second structural members 20, 22 are aligned to receive the axle of the drive bandwheel therethrough.

Turning to spacer components 24, they include a first upper plate 38, a second upper plate 40 and a centre plate 42. First upper plate 38 is secured to, and extends between, first segments 26 of structural members 20, 22 orientated along the first plane. Second upper plate 40 is secured to, and extends between, second segments 28 of structural members 20, 22 orientated along the second plane. Centre plate 42 is secured to, and extends between, centre segments 30 of structural members 20, 22 orientated along the third plane.

In that manner, first upper plate 38 and first segments 26 collectively form first platform 12, second upper plate 40 and second segments 28 collectively form second platform 14, and centre plate 42 and centre segments 30 collectively form centre platform 16.

Since the first and second planes of the present embodiment are coplanar, first upper plate 38 and second upper plate 40 are generally orientated coplanar with one another. As well, since the third plane of the present embodiment is parallel with the first and second planes, centre plate 42 is orientated parallel with, but spaced apart from, first upper plate 38 and second upper plate 40.

First platform 12 is depicted to further include a first lower plate 44 that is secured to first upper plate 38 around first segments 26 of structural members 20, 22. Second platform is also depicted to further include a second lower plate 46 secured to second upper plate 40 around second segments 28 of structural members 20, 22. In both cases, first lower plate 44 and second lower plate 46 are orientated parallel, respectively, with first upper plate 38 and second upper plate 40 to form plate stacks. Though not shown in the Figures, centre platform 16 may also include a lower centre plate.

For additional structural rigidity, support assembly 10 is shown to further include a pair of braces 48 extending between corresponding joint segments 32 of first and second structural members 20, 22. Braces 48 are rigid components that may be welded or secured to joint segments 32 with fasteners. In other applications, braces 48 may be additionally or alternately secured to first, second, and/or centre segments 26, 28, 30 with fasteners.

First and second platforms 12, 14 each include guide openings 54 situated in their respective first and second upper plates 38, 40, and the corresponding first and second lower plates 44, 46.

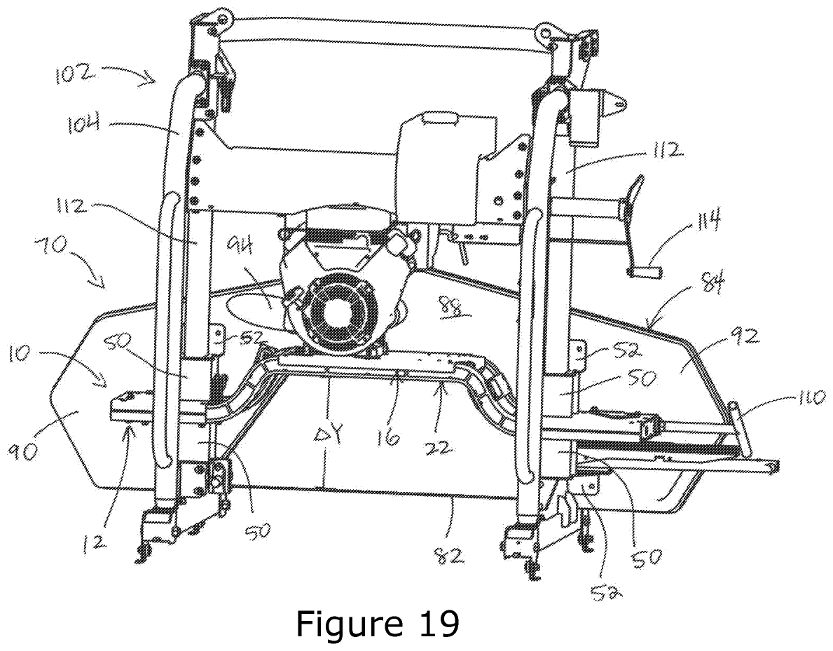

Accordingly, support assembly 10 may further include guide receivers 50 and brackets 52 positioned about guide openings 54. As shown in the Figures, guide receivers 50 are hollow column sections fastened to both sides of both first and second platforms 12, 14, whose openings are aligned with guide openings 54. Specifically, one guide receiver 50 is fastened to each of first upper plate 38, first lower plate 44, second upper plate 40, and second lower plate 46. Each pair of guide receivers 50 secured to first and second platforms 12, 14 are aligned together with their corresponding guide opening 54 and dimensioned to receive upright guide members 112 of a sawmill therethrough, as shown in FIG. 19.

To each guide receiver 50 is further fastened a bracket 52. Each bracket 52 is configured to be securable to a sawhead. In this manner, brackets 52 allow support assembly 10 to be secured to the sawhead of a sawmill.

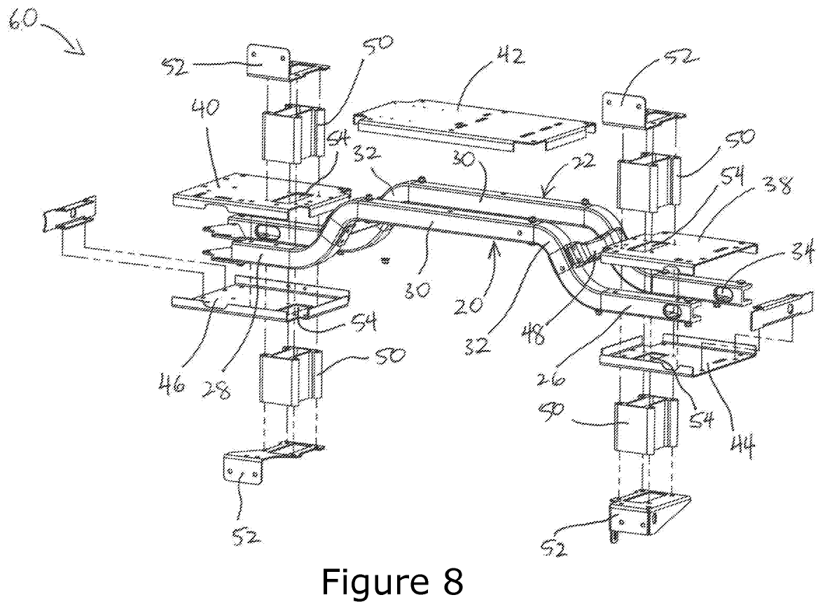

For ease of transportation, support assembly 10 may be provided in a kit 60 form, see FIGS. 8 and 9, for a user to assemble on their own. In such a case, the kit may include a first structural member and a second structural member, where each structural member has a first segment on a first plane, a second segment on a second plane, a centre segment on a third plane that is vertically spaced apart from the first and second planes, and a pair of joints connecting the first segment with one end of the centre segment, and connecting the second segment with another end of the centre segment. The kit would also include spacer components for securing the first and second structural members together, but spaced apart from one another.

In some applications, the first second, and centre segments, along with the joints, of each structural member are cast as a single unit. The first plane and the second plane of the first and second structural members may be coplanar, and the third plane may be parallel with the first and second planes.

The spacer components of the kit include a centre plate that is securable between the centre segments of the first and second structural members with fasteners, a first upper plate that is securable between the first segments of the first and second structural members with fasteners, and a second upper plate that is securable between the second segments of the first and second structural members with fasteners.

The spacer components may further include a first lower plate that is securable to the first upper plate around the first segments of the first and second structural members with fasteners, a second lower plate that is securable to the second upper plate around the second segments of the structural members with fasteners.

The kit may further comprise a pair of braces that are securable between the joints of the first and second structural members, and may comprise guide receivers and brackets for securing to the first and second upper and lower plates.

In the present embodiment, kit 60 includes first and second structural members 20, 22 and spacer components 24 as described above. Spacer components 24 comprise centre plate 42, first upper plate 38, second upper plate 40, first lower plate 44, and second lower plate 46. Kit 60 is shown to also include braces 48, guide receivers 50, and brackets 52.

All the parts of kit 60 may be secured together with fasteners. No welding is required. Thus, assembling support assembly 10 from kit 60 tends to be simpler and faster than the complicated welding necessary to modify existing sawheads to increase the throat clearance.

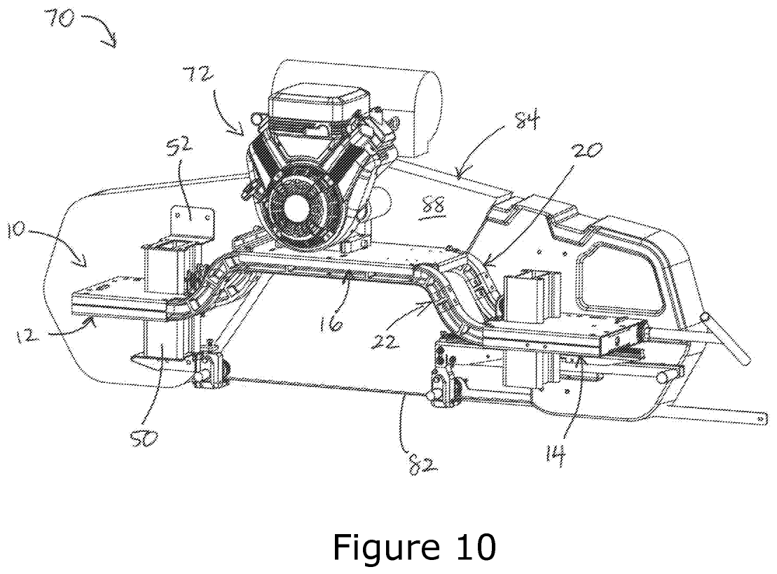

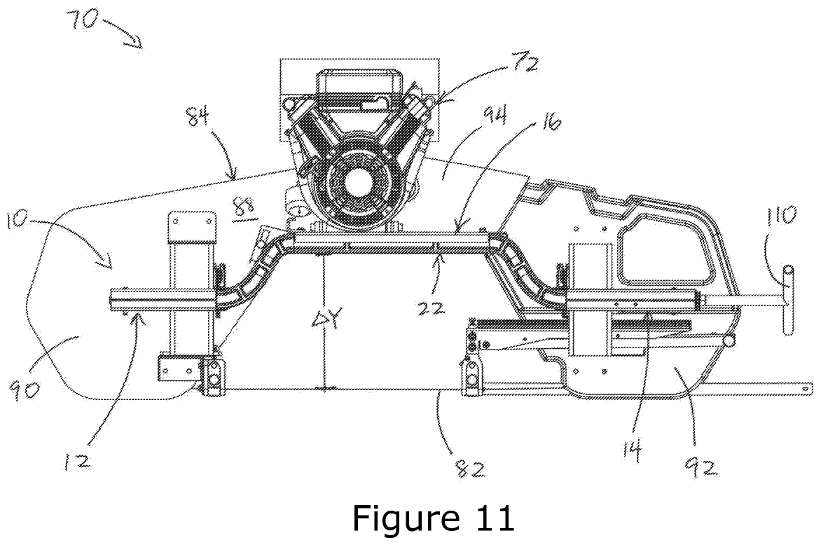

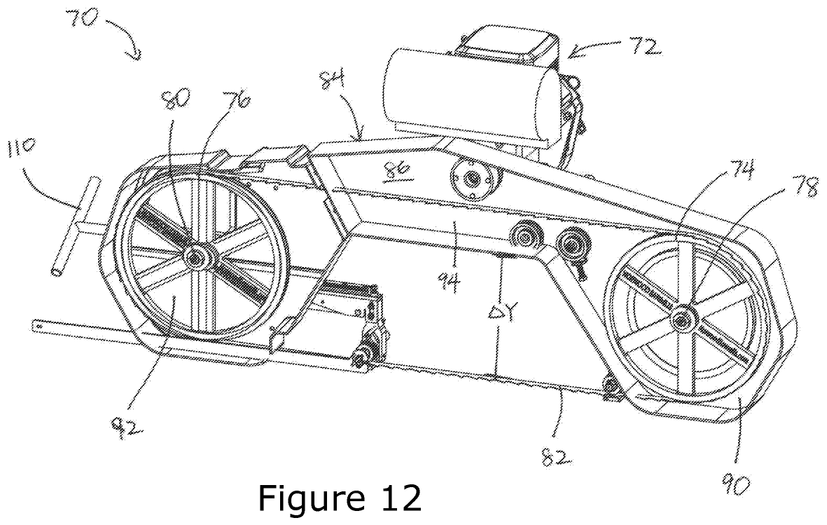

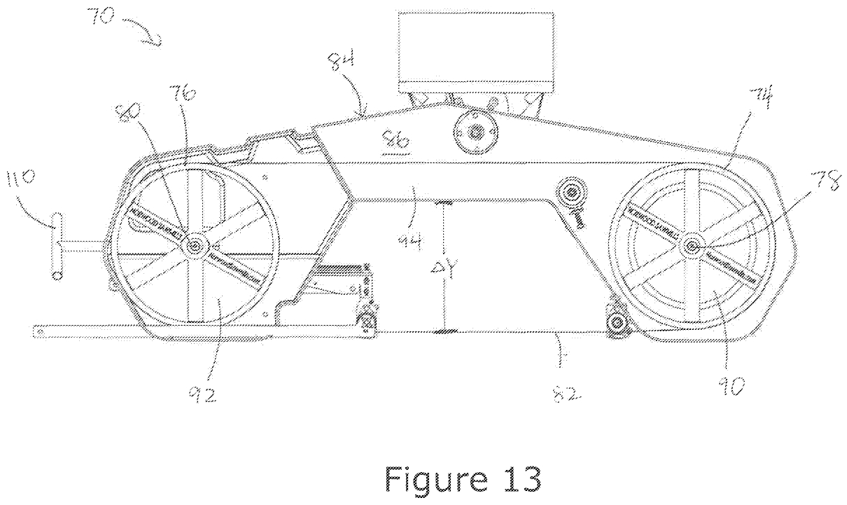

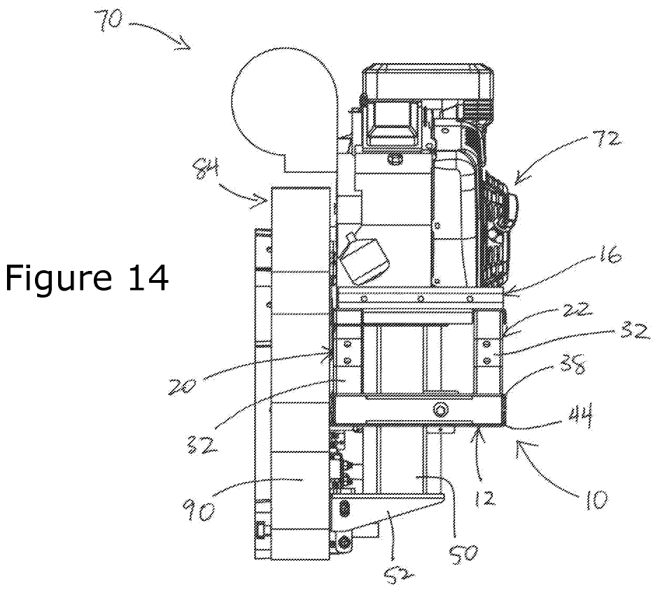

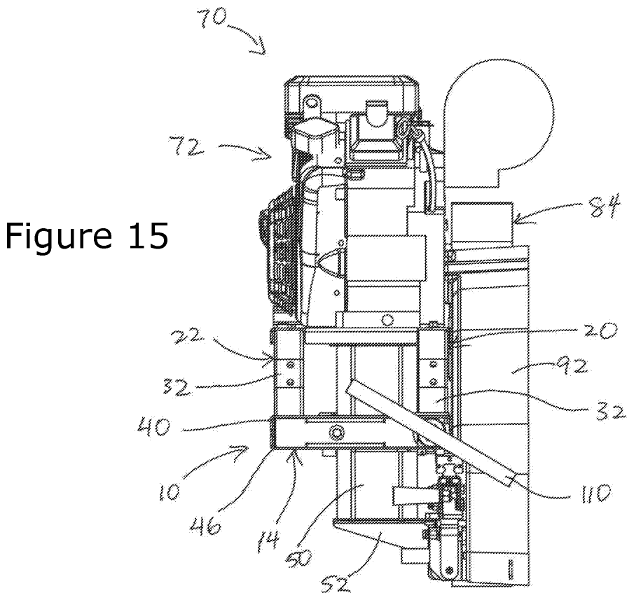

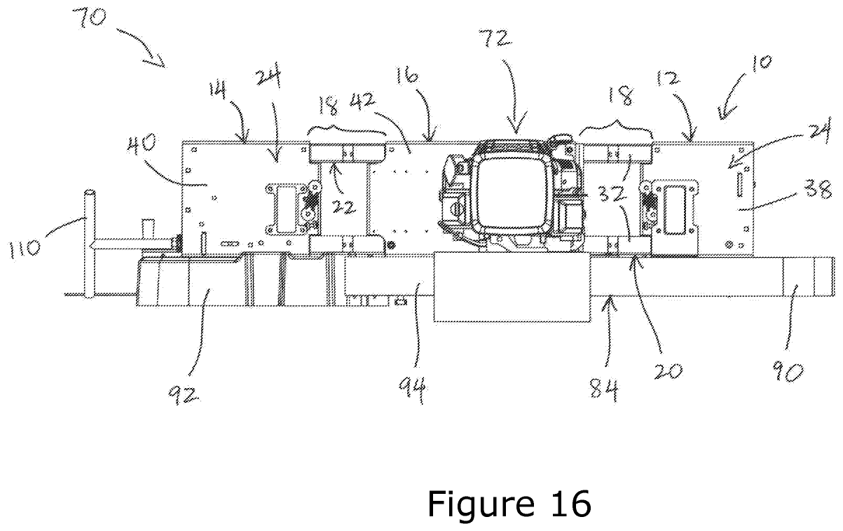

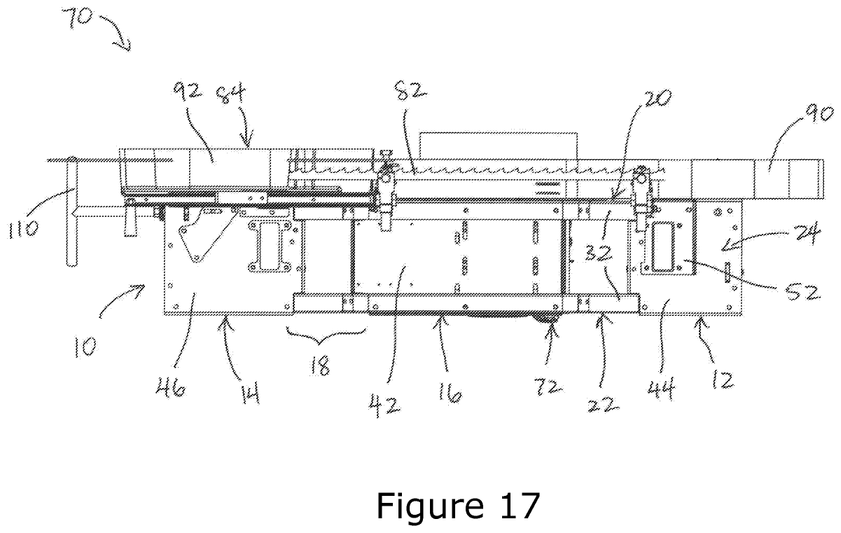

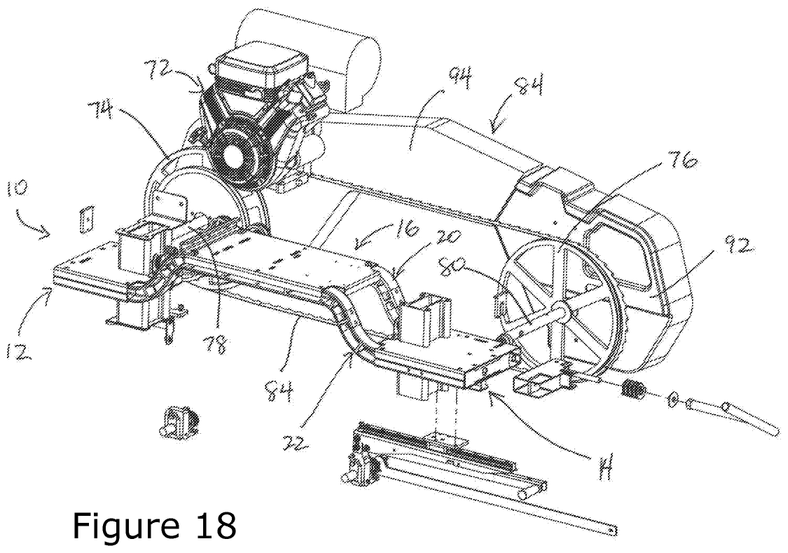

Turning to FIGS. 10-18, there is shown a sawhead 70 with support assembly 10 incorporated therein. Sawhead 70 also includes motor 72, drive bandwheel 74 with a drive axle 78, and free bandwheel 76 with a free axle 80.

Motor 72 is situated on, and supported by, centre platform 16 of support assembly 10. Drive bandwheel 74 is operatively coupled to, and actuated by, motor 72. Free bandwheel 76 is, in turn, operatively coupled to drive bandwheel 74 via a blade 82. Drive axle 78 of drive bandwheel 74 is secured to first platform 12, and free axle 80 is secured to second platform 14 of support assembly 10.

In the present embodiment, drive axle 78 is secured to first platform 12 by extending through drive axle apertures 34 in both first and second structural members 20, 22, and being fixed therein. Free axle 80 is secured to second platform 14 by extending through free axle apertures 36 in first structural member 20, and being fixed therein.

Since the third plane of centre platform 16 is vertically spaced apart from the planes of first and second platforms 12, 14, elevation of centre platform 16 above drive and free axles 78, 80 enlarges the throat clearance (ΔY) between blade 82 and centre platform 16. In such a manner, the throat clearance (ΔY) achieved by sawhead 70 is larger than the throat clearance that would result with a support assembly where the first, second, and centre platforms are all coplanar.

Sawhead 70 also includes a guard 84, with a front face 86 and a back face 88, positioned between support assembly 10 and motor 72, drive bandwheel 74, and free bandwheel 76. In particular, support assembly 10 is situated adjacent back face 88, and motor 72, drive bandwheel 74, and free bandwheel 76 are situated adjacent front face 86. In the shown embodiment, first structural member 20 is positioned against back face 88 of guard 84, and brackets 52 are secured thereto with fasteners.

Guard 84 is shown to have a drive section 90 for covering drive bandwheel 74, a free section 92 for covering free bandwheel, and a neck section 94 connecting drive section 90 and free section 92. When used with support assembly 10, neck section 94 extends above, and not below, centre platform 16, in order not to impede the throat clearance (ΔY) between blade 82 and centre platform 16.

To secure drive axle 78 to first platform 12, drive axle 78 extends through drive section 90, and then through drive axle apertures 34 in both first and second structural members 20, 22. To secure free axle 80 to second platform 14, free axle 80 extends through free section 92, and then through free axle aperture 36 in first structural member 20.

As shown, drive axle 78 is secured to drive section 90 such that drive bandwheel 74 is fully contained within drive section 90, and free axle 80 is secured to free section 92 such that free bandwheel 76 is fully contained within free section 92 of guard 84.

Unlike conventional modified sawheads that lower the bandwheels below the sawhead to increase the throat clearance, the present invention allows both drive bandwheel 74 and free bandwheel 76 to be fully contained within sawhead 70 while still increasing the throat clearance. This provides for better safety for the user and better protection for the bandwheels.

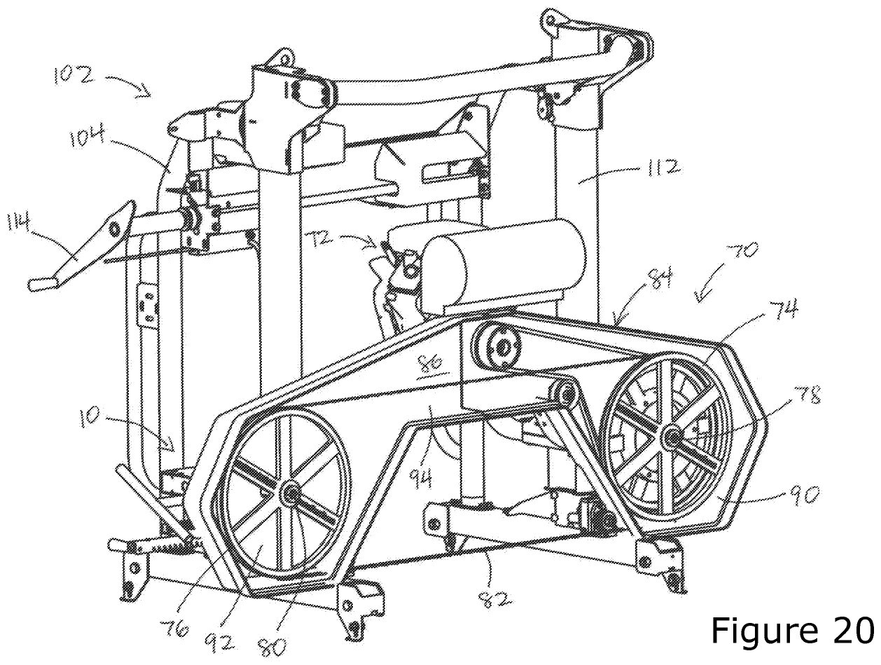

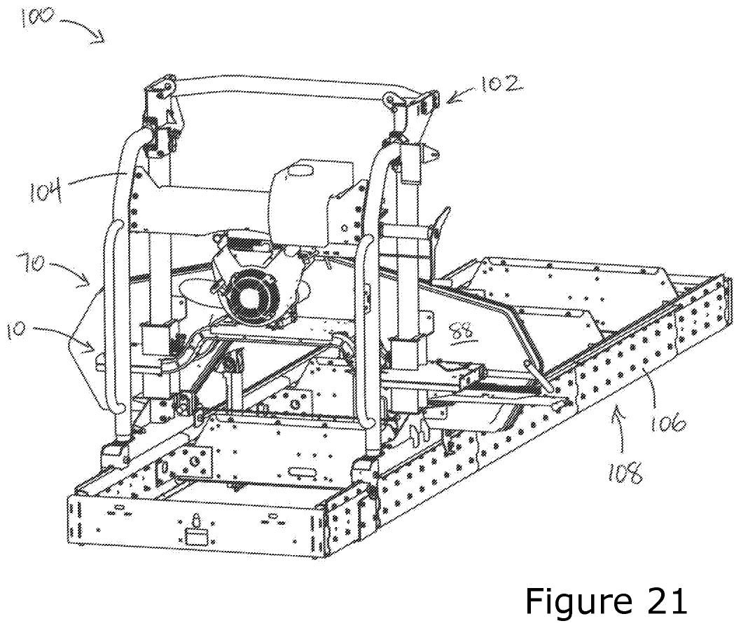

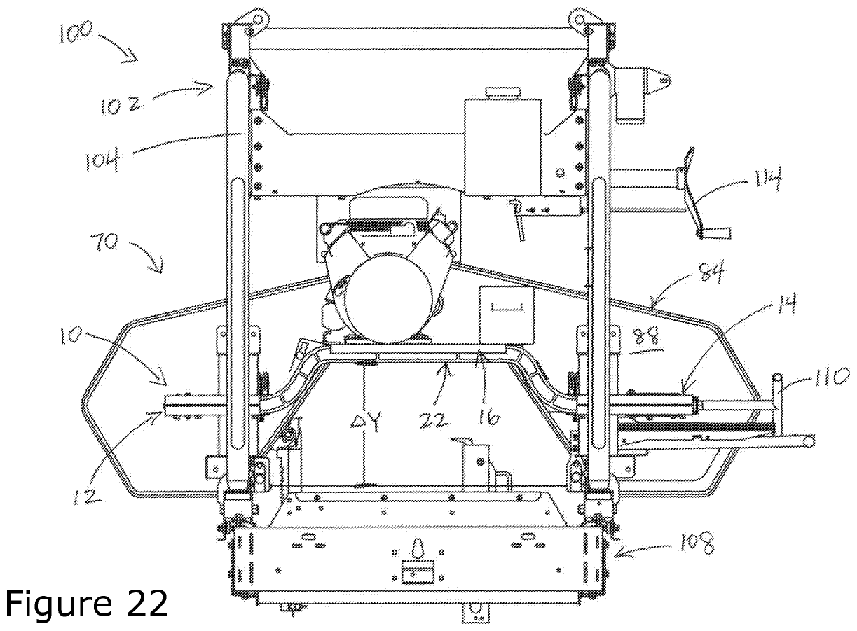

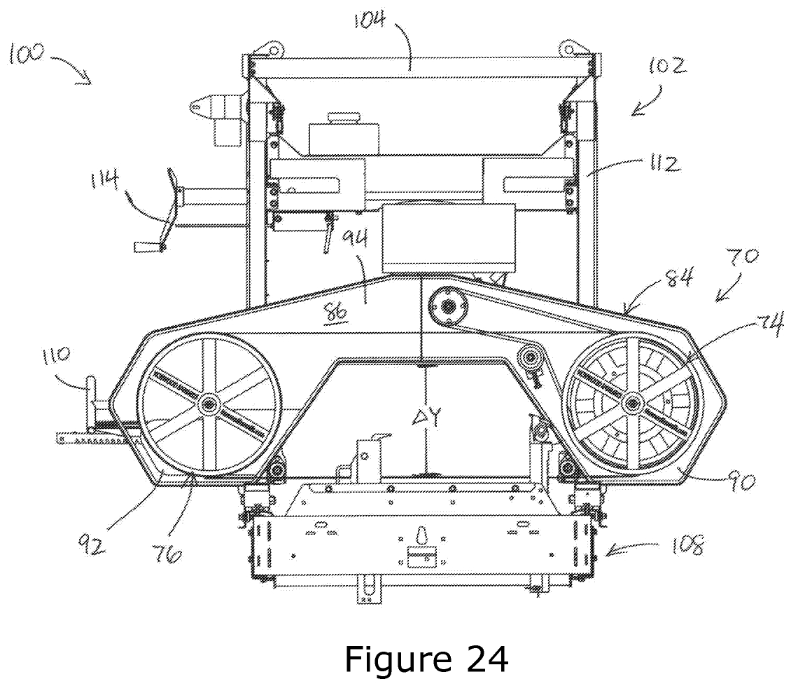

FIGS. 19-24 illustrate sawhead 70 secured to a carriage 102 and incorporated into sawmill 100. As noted above, sawhead 70 may be mounted along the path of travel of a log placed on a suitable moving bed with a mechanism for advancing the log relative to the blade.

Alternatively, as shown in the depicted embodiment, sawhead 70 is designed to be used as part of sawmill 100. Sawhead 70 is fitted to carriage 102 which is capable of longitudinal displacement on rails 106 of sawmill base 108. Tension on blade 82 is controlled by sawhead tension T handle 110. As well, sawhead 70 can be moved vertically along guide members 112 by operation of crank 114. As described above, guide members 112 extend through support assembly 10 by means of guide receivers 50 and guide openings 54.

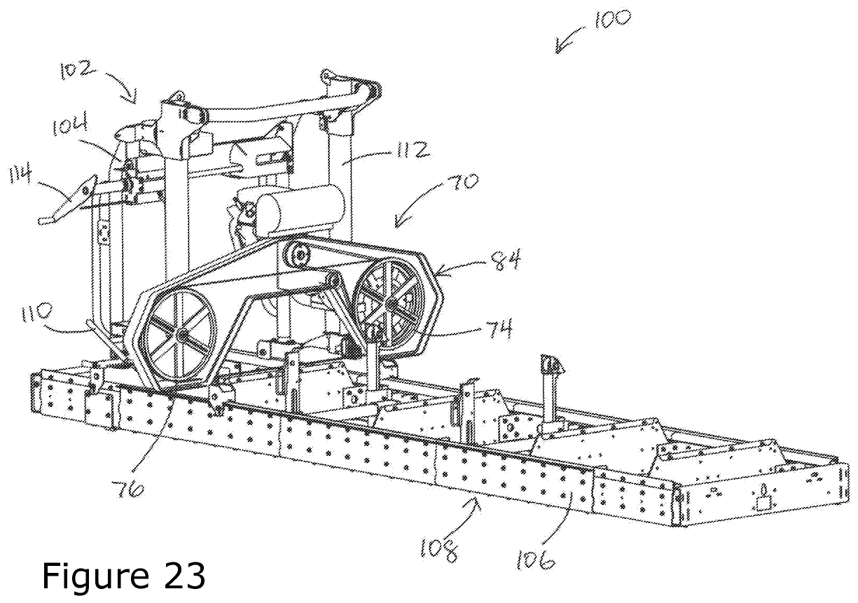

As seen in FIG. 23 the sawmill has a sawhead 70, a log bed sawmill base 108 defining a first translation axis, a carriage 102 mounted to the bed for movement along the first translation axis. A second translation axis is orientated transverse to the first translation axis and a lateral axis is orientated transverse to each of the first translation axis and the second translation axis. Two or more elongate guide members 112 secure to the carriage for movement therewith along the first translation axis. The guide members 112 are orientated parallel to the second translation axis and being spaced apart from one another in the direction of the lateral axis.

Raising motor 72 relative to drive bandwheel 74 and free bandwheel 76 allows for a greater throat clearance (ΔY) between blade 82 and neck section 94 of guard 84. The greater throat clearance allows part of a log to fit between the bandwheels well above the center or axles of the bandwheels. This helps to allow blade 82 to make a “deeper” cut into the log situated on sawmill base 108. In other words, the larger throat clearance allows blade 82 to cut the log along a plane that is further from a top surface of the log, providing more cutting options than a conventional sawhead.

Thus the present invention provides a sawhead which ensures proper bandsaw tracking on bandwheels, by rigorously fixing the distance between each bandwheel, and the alignment of each bandwheel and the saw blade. The bandwheels remain absolutely fixed in their predetermined locations. Thus during high pressure operation, the sawhead structure is highly rigid to resist deflection and torsion.

It is to be understood that what has been described are the preferred embodiments of the invention. The scope of the claims should not be limited by the preferred embodiments set forth above, but should be given the broadest interpretation consistent with the description as a whole.

What is claimed is:

1. A sawmill comprising:
a log bed defining a first translation axis,
a carriage mounted to the log bed for movement along the first translation axis,
a sawhead mounted to the carriage, the sawhead comprising a support assembly, a motor, a drive bandwheel and a free bandwheel, the support assembly comprising:
a first platform orientated on a first plane, the first platform secured to an axle of the drive bandwheel;
a second platform orientated on a second plane, the second platform secured to an axle of the free bandwheel; and
a centre platform coupled to and between the first and second platforms, the centre platform orientated on a third plane vertically spaced apart from the first and second planes, the centre platform configured to support the motor above the axle of the drive bandwheel and the axle of the free bandwheel,
a pair of joints, one joint of the pair of joints connecting the first platform with one end of the centre platform, and another joint of the pair of joints connecting the second platform with another end of the centre platform,
wherein the pair of joints are part of a first structural member and a second structural member; and
a brace securing the first structural member and second structural members together, wherein the first structural member is spaced apart from said second structural member;
the drive bandwheel operatively coupled to the motor;
the free bandwheel operatively coupled to the drive bandwheel by a blade;
wherein elevation of the centre platform above the axles enlarges a throat distance between the blade and the centre platform.

2. The sawmill of claim 1, wherein the first plane and the second plane are coplanar, and the third plane is parallel with the first and second planes.

3. The sawmill of claim 1, wherein each of the first structural member and second structural member comprises:
a first segment;
a second segment; and
a centre segment positioned between the first segment and second segment;
wherein the pair of joints comprises a joint segment connecting the first segment with one end of the centre segment, and another joint segment connecting the second segment with another end of the centre segment.

4. The sawmill of claim 3, further comprising:
a centre plate secured to, and extending between, the centre segments of the structural members, the centre plate and the centre segments forming the centre platform.

5. The sawmill of claim 3, further comprising:
a first upper plate secured to, and extending between, the first segments of the structural members, the first upper plate and the first segments forming the first platform; and
a second upper plate secured to, and extending between, the second segments of the structural members, the second upper plate and the second segments forming the second platform.

6. The sawmill of claim 5, wherein
the first platform further comprises a first lower plate secured to the first upper plate around the first segments of the structural members; and
the second platform further comprising a second lower plate secured to the second upper plate around the second segments of the structural members.

7. The sawmill of claim 3, wherein the first structural member further comprises a drive axle aperture positioned in the first segment for receiving an axle of the drive bandwheel therethrough.

8. The sawmill of claim 7, wherein the second structural member further comprises a free axle aperture positioned in the second segment for receiving an axle of the free bandwheel therethrough.

9. The sawmill of claim 8, wherein the axle of the drive bandwheel extends through the drive axle aperture, and the axle of the free bandwheel extends through the free axel aperture.

10. The sawmill of claim 1, wherein the structural members are U beams in cross section.

11. The sawmill of claim 1, further comprising a guard separating the support assembly from the drive bandwheel, the free bandwheel and the blade.

12. A kit for assembling the sawmill of claim 1, the kit comprising:
the log bed, the carriage, the sawhead, and the support assembly.

13. A kit for assembling the sawmill of claim 3, the kit comprising:
the log bed, the carriage, the sawhead, and the support assembly.

14. A kit for assembling the sawmill of claim 4, the kit comprising:
the log bed, the carriage, the sawhead, and the support assembly.

15. A kit for assembling the sawmill of claim 5, the kit comprising:
the log bed, the carriage, the sawhead, and the support assembly.

16. A kit for assembling the sawmill of claim 6, the kit comprising:
the log bed, the carriage, the sawhead, and the support assembly.

17. A kit for assembling the sawmill of claim 7, the kit comprising:
the log bed, the carriage, the sawhead, and the support assembly.

18. A kit for assembling the sawmill of claim 8, the kit comprising:
the log bed, the carriage, the sawhead, and the support assembly.

19. A kit for assembling the sawmill of claim 10, the kit comprising:
the log bed, the carriage, the sawhead, and the support assembly.

20. A kit for assembling the sawmill of claim 11, the kit comprising:
the log bed, the carriage, the sawhead, and the support assembly.
